(19) United States
(12) Patent Application Publication
(10) Pub. No.: US 2010/0214527 A1
(43) Pub. Date: Aug. 26, 2010

(54) LIQUID CRYSTAL OPTICAL SWITCH FOR OPTICAL SIGNAL HAVING ARBITRARY POLARIZATION

(76) Inventors: Xuefeng Yue, San Jose, CA (US); Ruipeng Sun, Pleasanton, CA (US); Ruibo Wang, Oak Park, CA (US)

Correspondence Address: PATTERSON & SHERIDAN, LLP, 3040 POST OAK BLVD, SUITE 1500, HOUSTON, TX, 77056, US

(21) Appl. No.: 12/392,800

(22) Filed: Feb. 25, 2009

(51) Int. Cl. G02F 1/13

(52) U.S. Cl. 349/196

(57) ABSTRACT

An optical device performs both switching and attenuation of an optical beam, where the beam has an arbitrary combination of s-polarized and p-polarized components. The optical device includes a birefringent displacer, a liquid crystal (LC) beam-polarizing structure having six subpixels organized in a first polarization group and a second polarization group, a half-wave plate positioned for polarization control of the second polarization group, and a polarization separating and rotating assembly. The structure of the LC beam-polarizing structure allows for 1×2 switching and attenuation control with a single control signal. The optical device may be configured for processing multiple input light beams, such as the multiple wavelength channels de-multiplexed from a wavelength division multiplexed (WDM) optical signal.

### BACKGROUND OF THE INVENTION

1. Field of the Invention

Embodiments of the present invention relate generally to optical communication systems and components and, more particularly, to a liquid crystal-based optical switch and attenuator.

2. Description of the Related Art

In optical communication systems, it is sometimes necessary to perform 1×2 switching of an optical signal, where an input light beam enters an optical switching device through an input port and is directed to one of two output ports. There are also more complicated optical switching schemes, such as 2×2, 1×N, and N×N optical switches, which may be realized by combining multiple 1×2 optical switches.

Liquid crystal (LC) based optical switches are known in the art, and in some applications, offer significant advantages over other optical switch designs, but there is one drawback related to the polarization state of an input light beam. Because LC-based optical switches rely on rotating the polarization state of linearly polarized input light to perform switching functions, the input light beam must have a single known polarization state for such an optical switch to vary the optical path of the light beam as desired. However, optical signals transmitted over optical fibers are usually randomly polarized, i.e., the optical signals have a random superposition of the s- and p-components, and each polarization component must be treated separately by an optical switch. An approach known in the art for managing s- and p-polarized components of a light beam involves performing a polarization “walk-off” with a birefringent optical element to spatially divide the light beam into s- and p-polarized light beams or components.

Polarization walk-off can be performed when an optical signal is first introduced into an LC-based optical switch, for example, as the optical signal exits an optical input fiber and becomes a free-space beam. After a birefringent optical element separates the optical signal into two physically displaced s- and p-polarized components, the polarization of one of the components can be rotated 90° to match the polarization of the other. In this way, the optical signal is converted into a pair of closely spaced, parallel beams having the same polarization state, and this pair of beams can be treated together by the optical switch as a single light beam having a known polarization state. However, such an approach requires the optical signal to be in the form of two parallel beams, sometimes over a long path length, which increases the likelihood of large polarization dependent loss (PDL). In addition, because a relatively large optical assembly is needed to perform the polarization walk-off as the optical signal exits the fiber, an undesirably large spacing between the input and output ports of the optical switch, e.g., greater than 1 mm, results.

Alternatively, polarization walk-off can be performed on an optical signal inside an optical switch, for example, a short distance from the LC pixels in the switch, producing a pair of closely spaced, parallel beams having opposite polarizations, i.e., s- and p-polarization. In this design, a half-wave plate is used to rotate the polarization of one of the parallel beams so that both beams have the same polarization and can be directed to a single LC pixel over a relatively short path length. As a result, the drawbacks associated with performing polarization walk-off upon entering the switch are avoided. However, this design dictates closely spaced LC pixels, making the manufacture of an optical switch with appropriately sized and positioned half-wave plates impracticable.

In addition to routing of signals by optical switches, attenuation of signals in optical communication systems is needed, for example in an optical communication system that employs wavelength division multiplexing (WDM). In such an optical system, information is carried by multiple channels, each channel having a unique wavelength. WDM allows transmission of data from different sources over the same fiber optic link simultaneously, since each data source is assigned a dedicated channel. The result is an optical communication link with an aggregate bandwidth that increases with the number of wavelengths, or channels, incorporated into the WDM signal. In this way, WDM technology maximizes the use of an available fiber optic infrastructure, such that what would normally require multiple optic links or fibers instead requires only one. In practice, different wavelength channels of a WDM signal typically undergo asymmetrical losses as they travel through an optical communication system, resulting in unequal intensities for each channel. Because these unequal intensities can compromise the integrity of the information carried by the WDM signal, an optical device or array of optical devices is typically used in WDM systems to perform wavelength-independent attenuation to equalize the respective intensities of the channels contained in a WDM signal.

While switching and attenuation of optical signals are known in the art, each of these operations is performed by a different optical device. The use of an optical device to perform switching and another device to perform attenuation in an optical communication system increases the size and complexity of the system, makes erosion of signal quality more likely due to misalignment of the optical devices, and requires a first independent control signal to complete the switching function and a second independent control signal to complete the attenuation function.

Accordingly, there is a need in the art for an optical switch for use in an optical network that is capable of both switching and attenuation of an optical signal in response to a single control signal, has closely spaced input and output ports, and is relatively easy to manufacture.

### SUMMARY OF THE INVENTION

Embodiments of the present invention provide an optical device for performing both switching and attenuation of an optical signal that has an arbitrary combination of s-polarized and p-polarized components.

According to one embodiment, an optical device comprises a birefringent displacer disposed in an optical path of an input beam and optical paths of multiple output beams that are produced from components of the input beam, a liquid crystal (LC) structure for conditioning the polarization state of incident light and disposed in optical paths of the components of the input beam and the optical paths of the multiple output beams, the LC structure having a plurality of LC cells arranged in a first group of adjacent LC cells and a second group of adjacent LC cells and an electrode that is arranged to apply a common electrical bias to the LC cells, and a half-wave plate that is disposed between the birefringent displacer and the LC structure. The half-wave plate is configured to rotate the polarization of an input beam component and the output beams that pass through the second group of adjacent LC cells, but does not affect the polarization of the input beam component and the output beams that pass through the first group of adjacent LC cells.

According to another embodiment, an optical device configured to switch and attenuate an input beam in response to a single control signal comprises a birefringent displacer disposed in an optical path of an input beam and optical paths of multiple output beams that are produced from components of the input beam, a liquid crystal (LC) structure for conditioning the polarization state of incident light and disposed in optical paths of the components of the input beam and the optical paths of the multiple output beams, the LC structure having a plurality of LC cells and a control electrode that applies the single control signal, and a half-wave plate disposed between the birefringent displacer and the LC structure and configured to rotate the polarization of an input beam component and the output beams that pass therethrough.

According to another embodiment, a wavelength selective switch comprises a wavelength dispersive element for separating an input beam into its wavelength components, a birefringent displacer disposed in optical paths of the wavelength components and optical paths of multiple output beams that are produced from the wavelength components, a liquid crystal (LC) structure for conditioning the polarization state of incident light and disposed in the optical paths of the wavelength components and the optical paths of the multiple output beams, the LC structure having a plurality of LC cells arranged in rows and columns, and a half-wave plate disposed between the birefringent displacer and the LC structure and configured to rotate the polarization of an input beam component and the output beams that pass therethrough.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 schematically illustrates a cross-sectional view of an optical device that is configured to provide 1×2 switching and attenuation of an optical signal in response to a single control signal, according to an embodiment of the invention.

FIGS. 2A, 2B illustrate the optical paths taken by the s- and p-components of an input beam when an optical device is configured to switch the input beam to an output port, according to an embodiment of the invention.

FIGS. 3A, 3B illustrate schematic side views of an LC beam-polarizing structure when configured to switch an input beam to an output port, according to an embodiment of the invention.

FIG. 4 illustrates a schematic side view of a birefringent assembly.

FIG. 5 illustrates a schematic side view of an optical device having a polarization-sensitive optical element, according to an embodiment of the invention.

FIG. 6 illustrates a schematic side view of an optical device configured with multiple polarization beam splitters, according to an embodiment of the invention.

FIG. 7A is a schematic top view of a wavelength selective switch that performs 1×2 switching and attenuation of a WDM signal, according to an embodiment of the invention.

FIG. 7B is a schematic side view of a wavelength selective switch that performs 1×2 switching and attenuation of a WDM signal, according to an embodiment of the invention.

FIG. 8 illustrates a schematic cross-sectional view of an LC beam-polarizing array for processing multiple input light beams, according to an embodiment of the invention.

For clarity, identical reference numbers have been used, where applicable, to designate identical elements that are common between figures. It is contemplated that features of one embodiment may be incorporated in other embodiments without further recitation.

### DETAILED DESCRIPTION

Embodiments of the invention contemplate an optical switching device that does not require polarization walk-off at the input fiber and that performs both 1×2 switching and attenuation of an optical beam in response to a single control signal. The optical device includes a birefringent displacer, a liquid crystal (LC) beam-polarizing structure having six subpixels arranged into a first polarization group and a second polarization group, a half-wave plate positioned for polarization control of the second polarization group, and a polarization separating and rotating assembly. The birefringent displacer separates input light beams into s- and p-polarized components before the components are conditioned by the LC beam-polarizing structure and combines the separate s- and p-polarized components of output light beams into their respective output beams after the components are conditioned by the LC beam-polarizing structure. The pixels in the first polarization group condition the components of input and output beams having one polarization, e.g. s-polarized light, while the pixels in the second polarization group condition the components of input and output beams having another polarization, e.g. p-polarized light. In addition, the structure of the LC beam-polarizing structure allows for 1×2 switching and attenuation control with a single control signal. By expanding the LC beam-polarizing structure into an array of such structures, the optical switching device may be configured for processing multiple input light beams, such as the multiple wavelength channels de-multiplexed from a wavelength division multiplexed (WDM) optical signal.

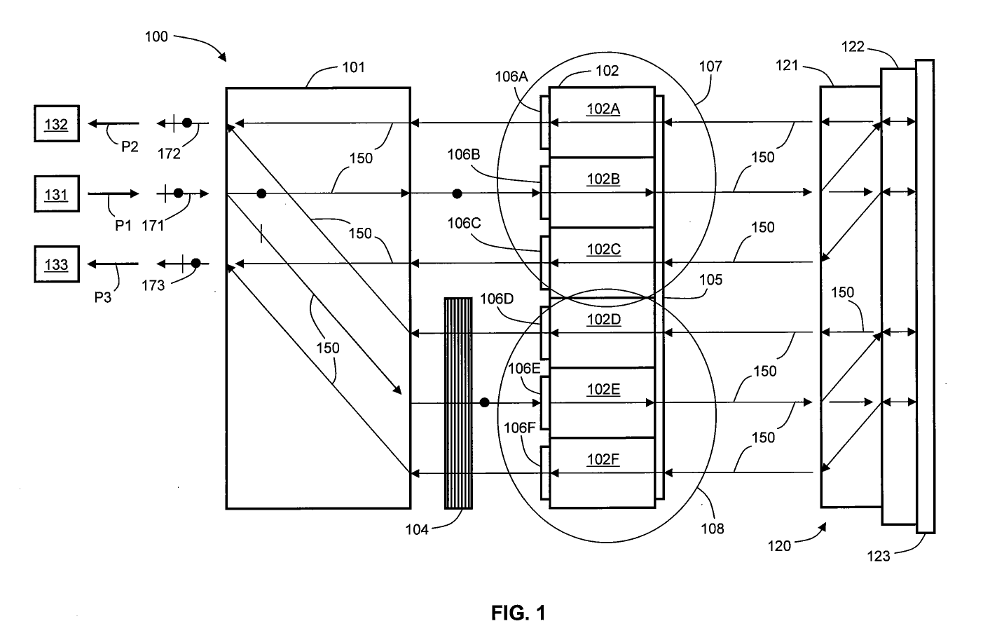

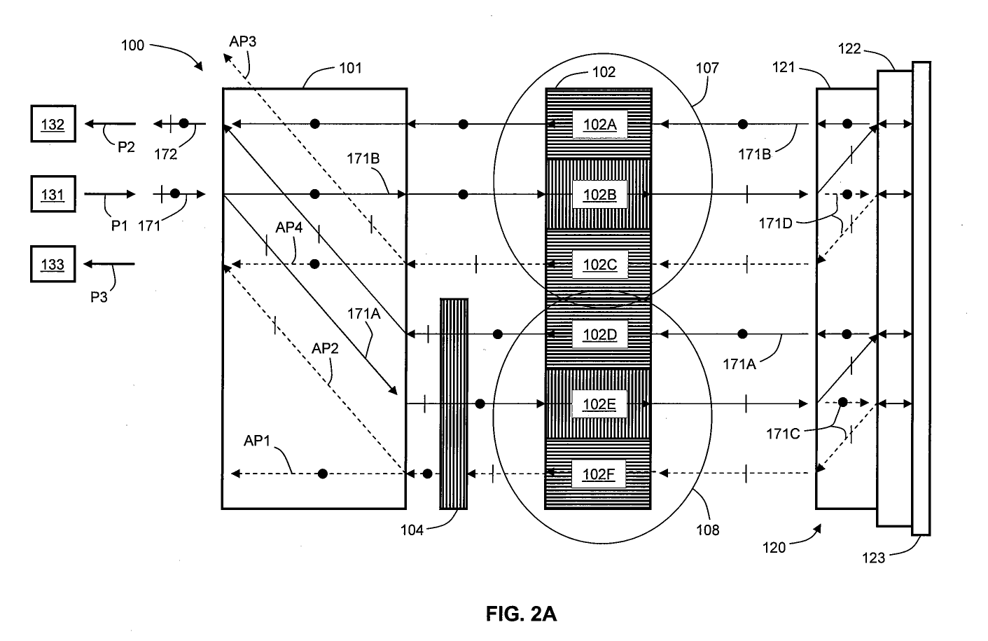

FIG. 1 schematically illustrates a cross-sectional view of an optical device 100 that is configured to provide 1×2 switching and attenuation of an optical signal in response to a single control signal, according to an embodiment of the invention. Optical device 100 includes a birefringent displacer 101, an LC beam-polarizing structure 102, a polarization separating and rotating assembly 120, and a half-wave plate 104, all of which are optically coupled as shown for the treatment, i.e., the switching and attenuation, of an input beam 171. To act as a 1×2 optical switch, optical device 100 is optically coupled to an input port 131 and output ports 132, 133 by optical paths P1, P2, and P3, respectively. The possible optical paths 150 of input beam 171, output beams 172, 173, and their respective s- and p-polarized components in optical device 100 are depicted as arrows. P-polarized light is denoted by a vertical bar, and s-polarized light by a dot. The specific optical paths 150 traveled by input and output beams in particular switching configurations of optical device 100, e.g., switching an input beam from input port 131 to output port 132, are described below in conjunction with FIGS. 2A-C.

Birefringent displacer 101 may be a YVO₄ crystal or other birefringent material that translationally deflects incident light beams by different amounts based on orthogonal polarization states. Birefringent displacer 101 is oriented relative to input beam 171 so that light of one polarization state (s-polarization, in the embodiment illustrated in FIG. 1) passes through birefringent displacer 101 without significant deflection and light of the opposite polarization state (p-polarization, in the embodiment illustrated in FIG. 1) passes through birefringent displacer 101 with the deflection shown. Consequently, the s-polarized component of input beam 171 is directed to a first polarization group 107 of LC beam-polarization structure 102 for polarization conditioning, and the p-polarized component of input beam 171 is directed to a second polarization group 108 of LC beam-polarization structure 102 for polarization conditioning. First and second polarization groups 107, 108 and polarization conditioning are described below.

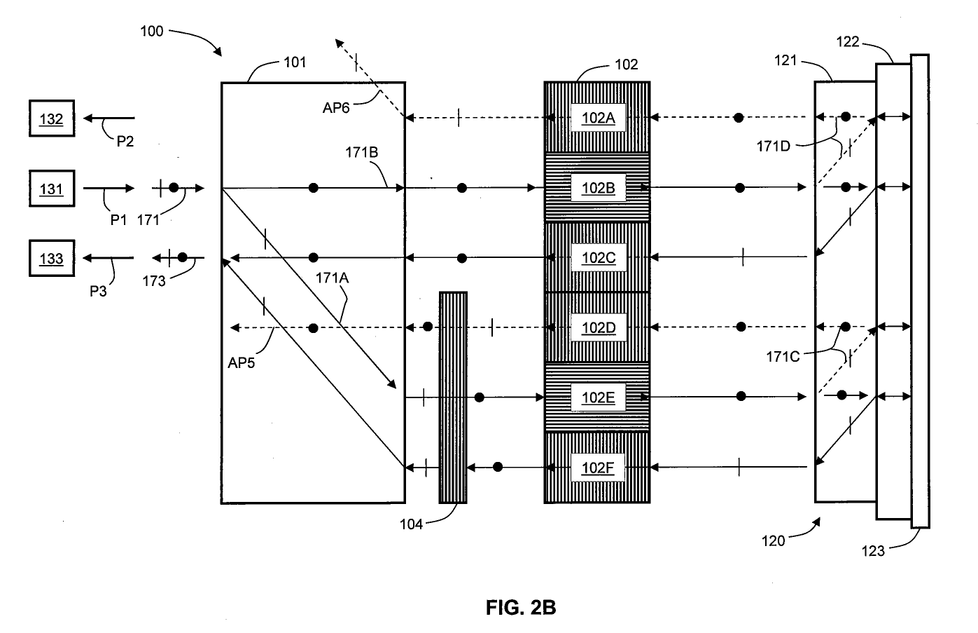

LC beam-polarizing structure 102 includes six LC subpixels 102A-F formed between two transparent plates (not shown for clarity), which are laminated together to form LC subpixels 102A-F using techniques commonly known in the art. Subpixels 102A-C are organized in a first polarization group 107 and subpixels 102D-F are organized in a second polarization group 108, as shown. LC subpixels 102A-F contain an LC material, such as twisted nematic (TN) mode material, electrically controlled birefringence (ECB) mode material, etc. LC beam-polarizing structure 102 also includes transparent electrodes that apply a potential difference across each of LC subpixels 102A-F, thereby selectively turning LC subpixels 102A-F “off” or “on,” i.e., setting each LC subpixel to either modulate or not modulate the polarity of incident light. For a twisted nematic mode material, a potential difference of approximately zero volts produces a 90° rotation of polarity and a potential difference of about 5 or more volts produces a 0° rotation of polarity. The transparent electrodes include a single vertical control electrode 105 and six horizontal electrodes 106A-F, and may be patterned from indium-tin oxide (ITO) layers. The transparent electrodes are covered with a buffered polyimide layer that determines LC configuration. Horizontal electrodes 106A-F are formed on a surface of one transparent plate and are positioned adjacent LC subpixels 102A-F, respectively, as shown. Similarly, vertical control electrode 105 is formed on a surface of the opposing transparent plate and is positioned adjacent to all six of LC subpixels 102A-F. By conditioning the polarization state of incident light, LC subpixels 102A-F in LC beam-polarizing structure 102 enable optical device 100 to perform both 1×2 switching and attenuation of input beam 171 having an arbitrary combination of s- and p-polarized light with only a single independent control signal and LC structure, as described below in conjunction with FIGS. 3A-C. References to the horizontal and vertical directions are for purposes of description only. One of skill in the art will recognize that optical device 100 may be configured in any orientation and perform 1×2 switching and attenuation as described herein.

Polarization separating and rotating assembly 120 includes a birefringent element 121, a quarter-wave plate 122, and a mirror 123. Birefringent element 121 may be substantially similar to birefringent displacer 101, except oriented with an optical axis so that an opposite deflection scheme is realized for incident light relative to the deflection scheme of birefringent displacer 101. Namely, for the embodiment illustrated in FIG. 1, incident p-polarized passes through birefringent displacer 121 with the deflection shown and s-polarized light passes through birefringent displacer 121 without significant deflection. Quarter-wave plate 122 is mounted on mirror 123, where mirror 123 reflects incident light as shown, and quarter-wave plate 122 rotates the polarization of incident light a total of 90° when incident light passes through quarter-wave plate 122 twice. Alternatively, in lieu of mirror 123, other optical apparatus can be devised by one of skill in the art to redirect light that has passed through LC beam-polarizing structure 102 and quarter-wave plate 122 back toward LC beam-polarizing structure 102 and quarter-wave plate 122 for a second pass.

Half-wave plate 104 is disposed between birefringent displacer 101 and LC beam-polarizing structure 102 and adjacent LC subpixels 102D-F. Being so placed allows half-wave plate 104 to rotate the polarization 90° of light entering and leaving LC subpixels 102D-F. By rotating incident s-polarized light 90° to become p-polarized light and vice-versa with half-wave plate 104, the control scheme for the subpixels in the first polarization group is symmetrical with the control scheme of the subpixels in the second polarization group. Such symmetry allows for 1×2 switching and attenuation using a single control signal, as detailed below in conjunction with FIGS. 3A-B.

In operation, optical device 100 performs 1×2 switching and attenuation on a linearly polarized input beam in response to a single control signal, where the input beam has an arbitrary combination of s-polarized and p-polarized components. As part of the 1×2 switching operation, optical device 100 can be configured to direct input beam 171 from input port 131 to output port 132 (as output beam 172), or to output port 133 (as output beam 173). 1×2 switching of input beam 171 between output ports 132 and 133 and attenuation of input 171 is accomplished by separating input beam 171 into s- and p-polarized components, conditioning the polarization of each component to a desired polarization using LC beam-polarizing structure 102, directing each component along an optical path based on the conditioned polarization of the component, and recombining the components to form an output beam. Polarization conditioning and other details of the switching and attenuation process are described below in conjunction with FIGS. 2A. One of skill in the art will appreciate that while the embodiment of optical device 100 as described herein is a 1×2 optical switch, optical device 100 is bi-directional in nature and may also operate equally effectively as a 2×1 optical switch. When optical device 100 operates as a 2×1 optical switch, input port 131 acts as the output port and output ports 132, 133 act as the input ports.

FIG. 2A illustrates the optical paths taken by the s- and p-components of input beam 171 when optical device 100 is configured to switch input beam 171 to output port 132, according to an embodiment of the invention. For clarity, vertical control electrode 105 and horizontal electrodes 106A-F are omitted from FIGS. 2A, 2B. Input beam 171 is directed from input port 131 to birefringent displacer 101 via optical path P1. Birefringent displacer 101 splits input beam 171 into two components 171A and 171B, where component 171A is the p-polarized component of input beam 171 and component 171B is the s-polarized component of input beam 171.

The path of component 171A through optical device 100 is described first. Component 171A is deflected downward as shown, exiting birefringent displacer 101 in alignment with half-wave plate 104 and subpixel 102E. Component 171A then passes through half-wave plate 104, is converted to s-polarization, and passes through subpixel 102E. Subpixel 102E conditions the polarization of component 171A as desired so that component 171A is subsequently directed to output port 132. In this embodiment, subpixel 102E is configured to rotate the polarization of component 171A 90° (denoted by lines in subpixel 102E perpendicular to component 171A), therefore component 171A is converted to substantially p-polarized after leaving subpixel 102E. To that end, a potential difference of zero volts is applied between the electrodes for subpixel 102E, i.e., horizontal electrode 106E and vertical control electrode 105. Component 171A enters birefringent element 121 and is deflected upward, enters quarter-wave plate 122, reflects off of mirror 123, passes back through quarter-wave plate 122 and birefringent element 121, and thus is directed to subpixel 102D. By passing through quarter-wave plate 122 twice, the polarization of component 171A is rotated 90°, therefore component 171A is converted to s-polarization and passes directly through birefringent element 121 without being deflected. In this embodiment, subpixel 102D is configured to rotate the polarization of component 171A 0° (denoted by lines in subpixel 102D parallel to component 171A), therefore component 171A is remains substantially s-polarized after leaving subpixel 102D. To that end, a potential difference of at least about 5V is applied between the electrodes for subpixel 102D. Such a potential difference across the LC material of subpixel 102D ensures that the extinction ratio of subpixel 102D is less than about −40 dB, that is, the intensity of s-polarized light in component 171A after passing through subpixel 102D is approximately four orders of magnitude greater than the intensity of p-polarized light in component 171A. Component 171A then passes through half-wave plate 104, is converted to p-polarization, and is incident on birefringent displacer 101. Birefringent displacer 101 combines component 171A with component 171B as shown to form output beam 172, which is directed along optical path P2.

In a similar fashion, component 171B, which is the s-polarized component of input beam 171, is directed through subpixels 102B and 102A to optical path P2 to be recombined with component 171A. It is noted that after the initial separation by birefringent displacer 101, the polarization conditioning and routing performed on components 171A and 171B are symmetrical. Namely, subpixel 102B performs the same polarization conditioning on component 171B that subpixel 102E performs on 171A. Likewise, subpixel 102A and polarization separating and rotating assembly 120 perform the same conditioning and routing functions on component 171B that subpixel 102D and polarization separating and rotating assembly 120 perform on component 171A. The symmetrical treatment of components 171A, 171B is enabled by the presence of half-wave plate 104 adjacent to the portion of LC beam-polarizing structure 102 that processes component 171B, i.e., second polarization group 108. When so disposed, half-wave plate 104 converts component 171B to the same polarization as component 171A, and all “down stream” components of optical device 100 can then be configured the same for both components.

It is known in the art that in certain voltage regimes LC-based optical switches have sub-optimal extinction ratio, making adequate switch isolation problematic. For example, at zero volts, a twisted nematic LC material may have an extinction ratio of only −10 to −15 dB. Consequently, after passing through such an LC, light initially having a single polarization may exit the LC with a residual quantity of optical energy having the opposite polarization. If there is directivity between the LC and an inactive output port, the unwanted residual light may be inadvertently directed to the inactive output port, which is highly undesirable. Optical device 100 avoids such a scenario by directing unwanted optical energy through LC structure 102 twice. In the second pass through LC structure 102, the polarization state of the residual beam is conditioned to a polarization state that can be subsequently filtered or redirected from an undesirable optical path.

FIG. 2A illustrates the optical paths of residual beams 171C, 171D, which are a product of components 171A, 171B passing through subpixels 102B, 102E, respectively. Residual beams 171C, 171D are made up of the small quantity of s-polarized light present in components 171A, 171B, respectively, after passing through subpixels 102B, 102E, respectively. Optical device 100 prevents a significant quantity of residual beams 171C, 171D from entering the inactive output port P3. For example, residual beam 171C is separated from component 171A by birefringent element 121, is converted to p-polarized by passing through quarter-wave plate 122 and is directed to subpixel 102F. Subpixel 102F is configured to rotate the polarization of residual beam 171C 0°, remaining substantially p-polarized after leaving subpixel 102F, and being converted to s-polarization by half-wave plate 104. The majority of optical energy in residual beam 171C then is directed along attenuation path AP1 by birefringent displacer 101 and does not enter output port 133. In practice, a small portion of the optical energy in residual beam 171C, i.e., any p-polarized light, is directed to output port 133 by birefringent displacer 101 via attenuation path AP2. Because subpixel 102F, like subpixels 102A, 102C, and 102D, has an extinction ratio of less than −40 dB in the configuration illustrated in FIG. 2A, the intensity of unwanted optical energy reaching output port 133 via attenuation path AP2 is insignificant. Similarly, optical device 100 directs the optical energy of residual beam 171D to attenuation path AP3, rather than to output port 133. Only the s-polarized portion of residual beam 171D is directed to output port 133 along attenuation path AP4, but as with residual beam 171C, the s-polarized portion has been reduced by at least 40 dB and is insignificant.

Optical device 100 may also perform attenuation of input beam 171, according to an embodiment of the invention. Attenuation of input beam 171 is accomplished by partially conditioning the polarization of input beam 171 with LC beam-polarizing structure 102 so that a portion of the optical energy of input beam 171 is directed to output port 132 and the remainder of the optical energy of input beam 171 forms residual beams that are directed along attenuation paths AP1 and AP3.

In such an embodiment, the potential difference applied across subpixels 102B and 102E is no longer maintained at zero volts. Instead, the potential difference is varied between zero and about 5 V so that subpixels 102B and 102E only partially condition the polarization of components 171A, 171B, respectively. In this way, the intensity of optical energy from input beam 171 that is ultimately directed to the desired output port, i.e., output port 132, may be reduced as desired. As a result, an increase in the intensity of optical energy portioned to residual beams 171C, 171D is increased accordingly. Thus, as input beam 171 is increasingly attenuated, residual beams 171C, 171D gain the attenuated light. As described above, the substantially all of the optical energy of residual beams 171C, 171D is directed along attenuation paths AP1, AP3, respectively, and does not enter the inactive output port, i.e., output port 133. When attenuating input beam 171, each of components 171A, 171B may be attenuated equally. In order to attenuate each of components 171A, 171B somewhat equally, the potential difference applied across each of subpixels 102B and 102E for a given attenuation is substantially the same.

FIG. 2B illustrates the optical paths taken by the s- and p-components of input beam 171 when optical device 100 is configured to switch input beam 171 to output port 133, according to an embodiment of the invention. In this configuration, components 171A and 171B and residual beams 171C, 171D follow different optical paths since subpixels 102A-F have a different potential difference applied thereacross. When optical device 100 is configured to switch input beam 171 to output port 133, a potential difference of at least about 5 V is applied across subpixels 102B and 102E so that polarized light passing therethrough does not change polarization. Conversely, a potential difference of about zero volts is applied across subpixels 102A, 102C, 102D, and 102F, so that the polarization of light passing therethrough is rotated 90°. As shown, components 171A and 171B are combined into output beam 173 and directed to output port 133, and residual beams 171C, 171D are directed along attenuation paths AP5, AP6.

Table 1 summarizes one electrode-biasing scheme for LC beam-polarizing structure 102, by which input beam 171 may be switched between output ports 132, 133, and/or be attenuated as desired by varying a single control signal, according to embodiments of the invention. In accordance with this biasing scheme, a first bias is applied to horizontal electrodes 106A, 106C, 106D, and 106F, a second bias of opposite polarity is applied to horizontal electrodes 106B and 106E, and a third bias is applied to vertical control electrode 105, where the third bias is the control signal. The control signal may range in value between the first and second biases for horizontal electrodes 106A-F. The potential difference developed between a horizontal electrode and vertical control electrode 105 determines the manner in which each LC pixel conditions an incident beam of linearly polarized light. Thus, the potential difference developed between vertical control electrode 105 and horizontal electrode 106A determines the polarizing effect of the LC subpixel 102A in LC beam-polarizing structure 102. For an LC pixel containing a twisted nematic (TN) mode LC material, a potential difference thereacross of up to about 1.2 V converts the majority of linearly polarized light from s- to p-polarized and vice versa. An LC pixel having a potential difference thereacross of more than about 4.0 V converts essentially none of the polarization of an incident beam. And an LC pixel having a potential difference thereacross of between about 1.2 V to 4.0 V partially converts the polarization of incident light as a function of the potential difference.

Table 1 presents the resultant potential difference (in volts or V) produced across each of subpixels 102A-F through which components 171A and 171B and residual beams 171C, 171D pass. The value of the resultant potential difference across each LC pixel is determined by cross-indexing the bias, in volts, applied to vertical control electrode 105 (given in Row 1 of Table 1) with the bias, in volts, applied to horizontal electrodes 106A-F (given in Column 1 of Table 1). In the example summarized by Table 1, a constant bias of +6 V is applied to subpixels 102A, 102C, 102D, and 102F via horizontal electrodes 106A, 106C, 106D, and 106F, respectively. A constant bias of −6 V is applied to subpixels 102B, 102E by horizontal electrodes 106B, 106E, respectively. The bias applied to vertical control electrode 105 may be varied between +6 V and −6 V.

TABLE 1
Resultant Potential Difference (in V) Across Subpixels of LC Beam-
Polarizing Structure 102

| | | Bias on Vertical Electrode 105 | | | | |
|---|---|---|---|---|---|---|
| | | +6 | +3 | 0 | −3 | −6 |
| Bias on 106A, 106C, | −6 | −12 | −9 | −6 | −3 | 0 |
| 106D, 106F | | | | | | |
| Bias on 106B, 106E | +6 | 0 | 3 | 6 | 9 | 12 |

| | | | |
|---|---|---|---|
| Output Port Status | 133 | BLOCKING | ATTENUATING |

| | | |
|---|---|---|
| 132 | ATTENUATING | BLOCKING |

Referring to Table 1, the resultant potential difference that may be produced across each LC pixel of LC beam-polarizing structure 102 ranges from −12 V to +12 V. Therefore, subpixels 102A-F may be set to fully or partially convert the polarization of incident light, or to allow incident light to pass through unconverted. As summarized in Rows 4 and 5 of Table 1, by varying the bias applied to vertical control electrode 105, incident light beams may be fully or partially directed to optical output port 132, output port 133, or blocked, i.e., directed along an attenuation path.

FIG. 3A illustrates a schematic side view of LC beam-polarizing structure 102 when configured to switch input beam 171 to output port 133. Subpixels 102B and 102E have a potential difference of zero volts applied thereacross and allow incident light 301 to pass through with substantially no change in polarization state, while subpixels 102A, 102C, 102D, and 102F have a potential difference of 12 V applied thereacross and rotate the polarization state of incident light 301 by 90°. FIG. 3B illustrates a schematic side view of LC beam-polarizing structure 102 when configured to switch input beam 171 to output port 132, with the conditioning state of each of subpixels 102A-F illustrated accordingly. Because subpixels 102C and 102D have the same potential difference applied thereacross in all switching states of optical device 100, subpixels 102C, 102D may, in one embodiment, be formed from a single LC cavity and share a single horizontal electrode in order to simplify manufacture of optical device 100.

In sum, the bias value of vertical control electrode 105 determines the portion of an input beam 171 that is attenuated, i.e., conditioned to an opposite polarization state than is desired to enter an output port and thereby directed to an attenuation path. In this way, 1×2 switching and attenuation of input beam 121 is controlled by a single control signal and is performed by a single (i.e., an uncascaded) LC structure. Such an arrangement reduces the size and complexity of an optical system performing the switching and attenuation functions. In addition, control of such a system is simplified, since only a single control signal is required to control both functions.

One of skill in the art will appreciate that the specific values disclosed in Table 1 for the biasing scheme for vertical control electrode 105 and horizontal electrodes 106A-F may be altered in embodiments of the invention. For example, because the behavior of LCs is a function of the potential difference between vertical control electrode 105 and horizontal electrodes 106A-F, it is contemplated that the bias on all electrodes may be increased or decreased the same amount without affecting the behavior of subpixels 102A-F. Further, the range of potential difference between said electrodes need not be held to exactly −12 V to +12 V. Depending on what LC material is present in subpixels 102A-F, the potential differences disclosed in Table 1 may be altered in order to optimize the optical performance of said LC materials.

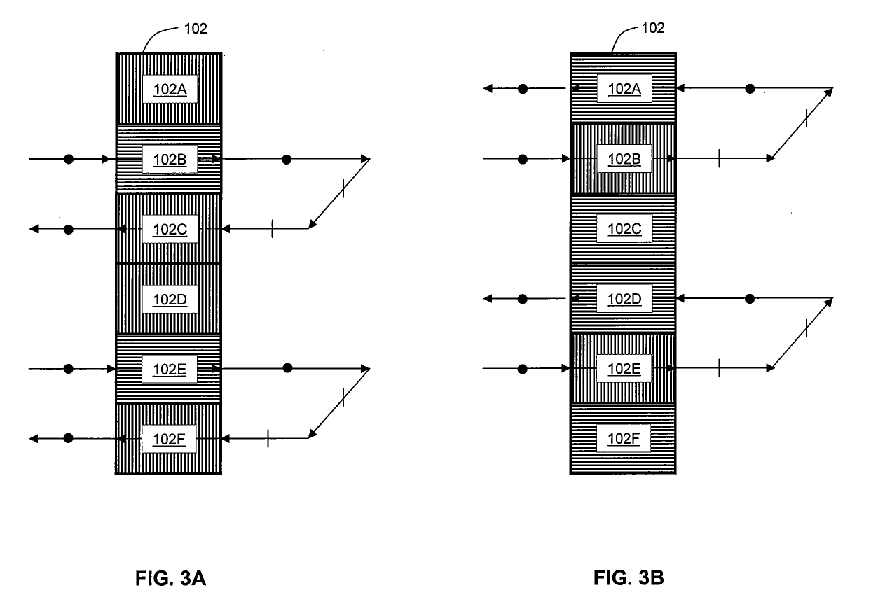

Referring back to FIG. 2A, the optical path lengths of components 171A and 171B through birefringent displacer 101 are substantially different, which may produce significant polarization mode dispersion (PMD) and other issues. One of skill in the art will recognize that birefringent displacer 101 in optical device 100 may be replaced with a birefringent assembly that provides equal path lengths for components 171A and 171B. FIG. 4 illustrates a schematic side view of one example of such an assembly. Birefringent assembly 400 includes a first birefringent crystal 401 and a second birefringent crystal 402 that, when configured as shown, provide equal optical path lengths for s-polarized component 403 and p-polarized component 404 of an input beam 405. In one embodiment, a half-wave plate 406 may be installed between first birefringent crystal 401 and second birefringent crystal 402 to provide a preferred arrangement for s-polarized component 403 and p-polarized component 404. In another embodiment, an additional element may be placed in the optical paths associated with subpixels 102A-C in FIG. 2A to balance the difference in polarization path length caused by the presence of half-wave plate 104 in the optical paths associated with subpixels 102D-F.

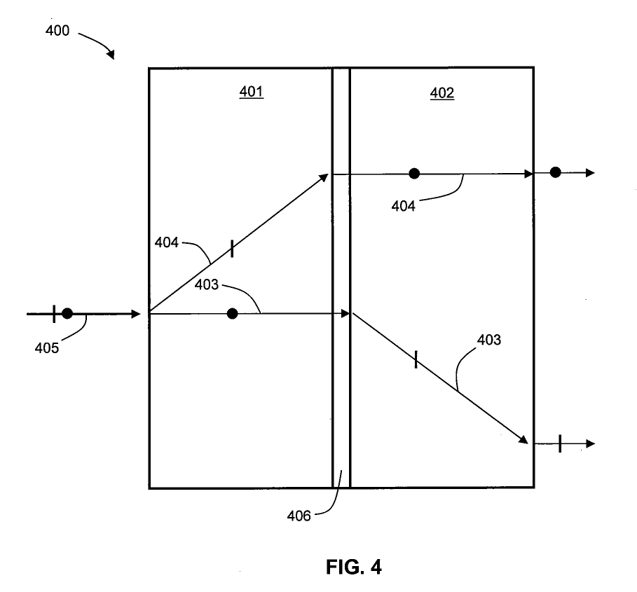

In one embodiment, residual beams containing unwanted optical energy are directed through a polarization-sensitive optical element rather than along one or more attenuation paths, as illustrated in FIGS. 2A, 2B. FIG. 5 illustrates a schematic side view of an optical device 500 having a polarization-sensitive optical element, according to an embodiment of the invention. Optical device 500 is substantially similar to optical device 100, except for the inclusion of polarization-sensitive optical element 501 disposed between half-wave plate 104 and LC beam-polarizing structure 102. By way of illustration, the optical paths are depicted for components 171A and 171B when optical device 500 is configured to switch input beam 171 to output port 132. Polarization-sensitive optical element 501 may be an absorptive polarizer designed to transmit light of a single polarization, in this case s-polarized light, such as a polarization-dependent isolator, and to absorb or reflect all other incident light. One example of an absorptive polarizer is a wire-grid polarizer. Alternatively, polarization-sensitive optical element 501 may be a birefringent beam displacer similar to birefringent displacer 101, and is oriented to direct incident p-polarized light to a loss port, light dump, or other means of elimination. Thus, any p-polarized light directed through polarization-sensitive optical element 501 is absorbed, reflected, or directed away from output port 133.

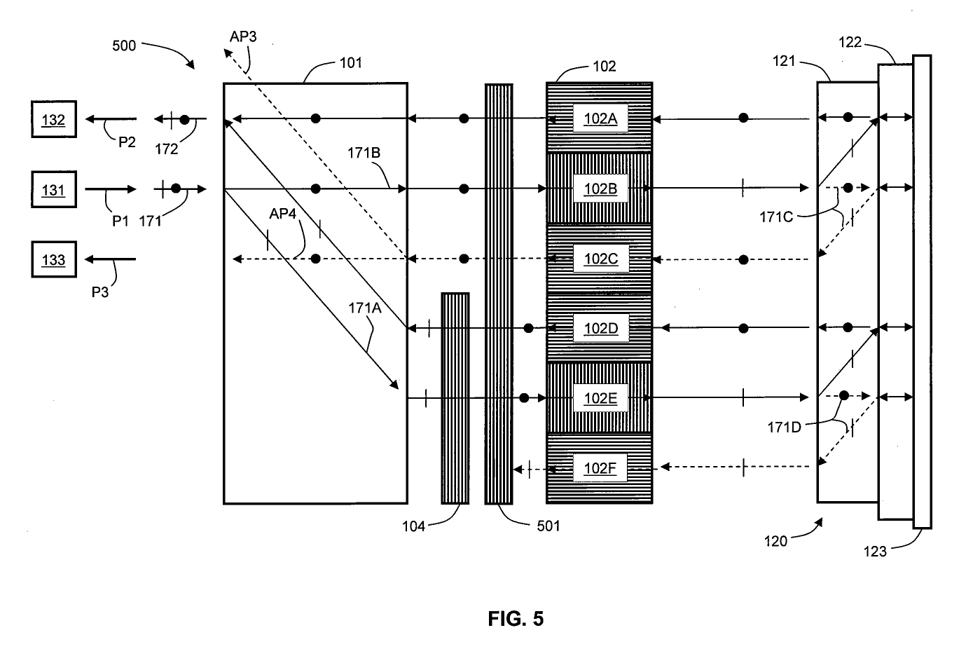

In one embodiment, a polarization beam splitter, e.g., a Wollaston prism, is used as birefringent displacer 101 to separate an input beam into s- and p-polarized components, instead of a YVO₄ crystal. Additional polarization beam splitters may also be used to direct unwanted optical energy of one polarization to a loss port, light dump, or other means of elimination and an output beam of another polarization to an output port. FIG. 6 illustrates a schematic side view of an optical device 600 configured with multiple polarization beam splitters, according to an embodiment of the invention.

Optical device 600 is substantially similar to optical device 100, except that a Wollaston prism 601 and an optical array 610 are used in lieu of a YVO₄ crystal. Wollaston prism 601 separates input 171 beam into s- and p-polarized components and optical array 610 selectively directs said components to LC structure 102 and output ports 132, 133. Optical array 610 includes a mirror 611, a combining optic 612, and Wollaston prisms 613, 614, and 615. By way of illustration, the optical paths depicted in FIG. 6 are for components 171A and 171B when optical device 600 is configured to switch input beam 171 to output port 132. Wollaston prisms 613, 614, and 615 are configured to direct output beams to the active output port, e.g. output port 132, and residual beams away from the inactive output port e.g. output port 133. As with optical device 100 in FIGS. 2A, 2B, only residual beams that have been reduced by at least 40 dB are directed to the inactive output port.

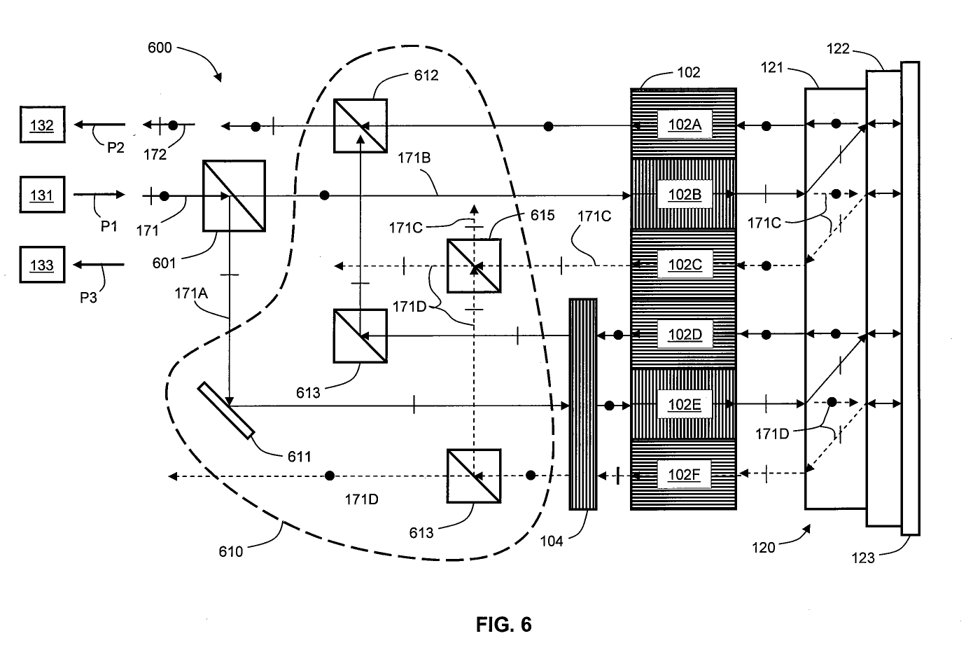

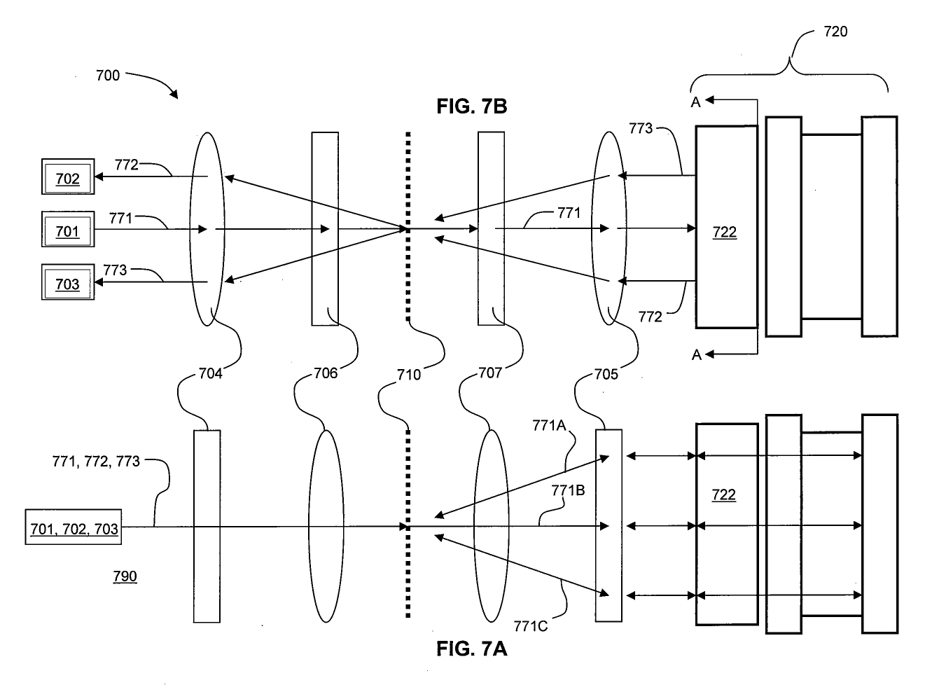

FIG. 7A is a schematic top view of a WSS 700 that performs 1×2 switching and attenuation of a WDM signal, according to an embodiment of the invention. FIG. 7B is a schematic side view of WSS 700. WSS 700 can selectively direct each of the wavelength channels of an input light beam to one of two output optical paths. For example, an input light beam containing a plurality of wavelength channels enters through an input fiber and each of the individual wavelength channels may be directed to one of two output fibers. Embodiments of the invention contemplate the incorporation of an optical device substantially similar to optical device 100 into WSS 700. The LC-based optical switching device provides selective 1×2 switching and attenuation of the wavelength channels contained in a WDM signal. The terms “top view” and “side view” and references to the horizontal and vertical directions are for purposes of description only. One of skill in the art will recognize that WSS 700 may be configured in any orientation and perform 1×2 switching and attenuation as described herein.

WSS 700 includes an optical input port 701, optical output ports 702 and 703, beam shaping optics, a diffraction grating 710 and an optical switching assembly 720. WSS 700 may also include additional optics, such as mirrors, focusing lenses, and other steering optics, which have been omitted from FIGS. 7A, 7B for clarity. The beam shaping optics include x-cylindrical lenses 704, 705 and y-cylindrical lenses 706, 707. The components of WSS 700 are mounted on a planar surface 790 that is herein defined as the horizontal plane for purposes of description. In the example described herein, planar surface 790 is substantially parallel to the plane traveled by light beams interacting with WSS 700. Also for purposes of description, the configuration of WSS 700 described herein performs wavelength separation of a WDM signal in the horizontal plane and switching selection, i.e., channel routing, in the vertical plane.

Optical input port 701 optically directs a WDM optical input signal 771 to the WSS 700. Optical input signal 771 includes a plurality of multiplexed wavelength channels and has an arbitrary combination of s- and p-polarization. X-cylindrical lens 704 vertically extends inbound beam 750, and cylindrical lens 716 horizontally extends inbound beam 750. Together, X-cylindrical lens 704 and Y-cylindrical lens 706 shape optical input signal 771 so that the beam is elliptical in cross-section when incident on diffraction grating 710, wherein the major axis of the ellipse is parallel with the horizontal plane. In addition, X-cylindrical lens 704 and Y-cylindrical lens 706 focus optical input signal 771 on diffraction grating 710.

Diffraction grating 710 is a vertically aligned diffraction grating configured to spatially separate, or demultiplex, each wavelength channel of optical input signal 771 by directing each wavelength along a unique optical path. In so doing, diffraction grating 717 forms a plurality of inbound beams, wherein the number of inbound beams corresponds to the number of optical wavelength channels contained in optical input signal 771. In FIG. 7A, diffraction grating 710 is depicted separating optical input signal 771 into three input signals 771A-C. In practice, the number of optical channels contained in input signal 771 may be up to 50 or more. Because the separation of wavelength channels by diffraction grating 710 takes place horizontally in the configuration shown in FIGS. 7A, 7B, spectral resolution is enhanced by widening inbound beam 750 in the horizontal plane, as performed by Y-cylindrical lens 706. Diffraction grating 710 also performs wavelength channel combination, referred to as multiplexing, of output beams 772, 773.

Together, X-cylindrical lens 705 and Y-cylindrical lens 707 columnate optical input signal 771 so that the beam is normally incident to the first element of optical switching assembly 720, i.e., birefringent displacer 101. In addition, X-cylindrical lens 705 and Y-cylindrical lens 707 focus output beams 772, 773 on diffraction grating 710 after the beams exit optical switching assembly 720.

Optical switching assembly 720 is similar in organization and operation to optical device 100 in FIGS. 1, 2A, and 2B, except modified to condition the plurality of horizontally displaced wavelength channels de-multiplexed from optical input signal 771. To that end, optical switching assembly 720 includes an LC beam-polarizing array of structures similar to optical device 100.

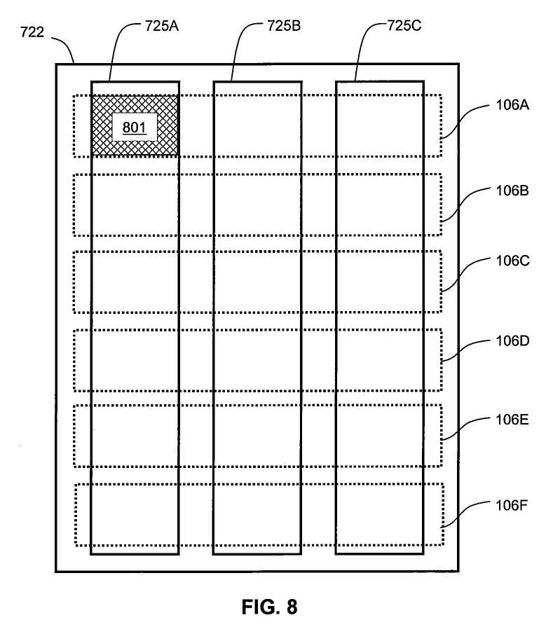

FIG. 8 illustrates a schematic cross-sectional view of an LC beam-polarizing array 722 for processing multiple input light beams, according to an embodiment of the invention. FIG. 8 is taken at section line A-A of LC beam-polarizing array 722, as indicated in FIG. 7. LC beam-polarizing array 722 includes a plurality of vertical control electrodes 725A-C and a plurality of horizontal electrodes 106A-F. Each of vertical control electrodes 725A-C is substantially similar in configuration to vertical control electrode 105 in FIG. 1, and corresponds to one of the wavelength channels into which optical input signal 771 is de-multiplexed. To that end, each of vertical control electrodes 725A-C is positioned appropriately so that the desired wavelength channel is incident on the requisite vertical electrode. For clarity, vertical electrodes for only three channels are illustrated in FIG. 8. Vertical electrode arrays configured for 50 or more wavelength channels are also contemplated. Horizontal electrodes 106A-F act as common electrodes for all wavelength channels processed by LC beam-polarizing array 722. The subpixels of LC beam-polarizing array 722 are defined by the regions between vertical control electrodes 725A-C and horizontal electrodes 106A-F. The cross-hatched region in vertical electrode 725A indicates one such subpixel 801 of LC beam-polarizing array 722.

In operation, WSS 700 performs optical routing of a given wavelength channel by conditioning (via LC polarization) and vertically displacing the s- and p-components of the channel in the same manner described above for input beam 171 in optical device 100. Thus, output beam 772, which is vertically displaced below input beam 771 in LC beam-polarizing array 722, includes the wavelength channels selected for output port 702. Similarly, output beam 773, which is vertically displaced above input beam 771 in LC beam-polarizing array 722, includes the wavelength channels selected for output port 703. Attenuation may also be performed on each wavelength channel independently in the manner described above for input beam 171 in optical device 100.

In sum, WSS 700 is an optical switching device that is capable of performing both WDM signal routing and wavelength independent attenuation on an input beam having an arbitrary combination of s- and p-polarization. A single half-wave plate is disposed between the birefringent displacer and the LC beam-polarizing structure of the WSS, which is not difficult to manufacture. Because polarization walk-off is not required by the WSS at the input fiber, a significant source of polarization dependent loss is avoided. In addition, the individual channels contained in a WDM signal can be equalized by the same optical switching device that performs 1×2 switching of the wavelength channels, thereby simplifying the fabrication, alignment, and control of the optical switching device.

While the foregoing is directed to embodiments of the present invention, other and further embodiments of the invention may be devised without departing from the basic scope thereof, and the scope thereof is determined by the claims that follow.

We claim:

1. An optical device comprising:
a birefringent displacer disposed in an optical path of an input beam and optical paths of multiple output beams that are produced from components of the input beam;
a liquid crystal (LC) structure for conditioning the polarization state of incident light and disposed in optical paths of the components of the input beam and the optical paths of the multiple output beams, the LC structure having: (i) a plurality of LC cells arranged in a first group of adjacent LC cells and a second group of adjacent LC cells, and (ii) an electrode that is arranged to apply a common electrical bias to the LC cells; and
a half-wave plate disposed between the birefringent displacer and the LC structure and configured to rotate the polarization of an input beam component and the output beams that pass through the second group of adjacent LC cells, wherein the half-wave plate does not affect the polarization of the input beam component and the output beams that pass through the first group of adjacent LC cells.

2. The optical device according to claim 1, further comprising a second birefringent displacer disposed in the optical paths of the components of the input beam after the components of the input beam have passed through the LC structure, wherein the second birefringent displacer produces the multiple output beams from the components of the input beam.

3. The optical device according to claim 2, further comprising a reflective element disposed in the optical paths of the multiple output beams to redirect the multiple output beams back through the second birefringent displacer, the LC structure, and the first birefringent displacer.

4. The optical device according to claim 3, further comprising a quarter-wave plate disposed between the second birefringent displacer and the reflective element.

5. The optical device according to claim 1, wherein:
the LC structure includes a first LC cell through which a first output beam passes, a second LC cell through which a first input beam component passes, a third LC cell through which a second output beam passes, a fourth LC cell through which a third output beam passes, a fifth LC cell through which a second input beam component passes, and a sixth LC cell through which a fourth output beam passes; and
the first and second output beams are produced from the first input beam component and the third and fourth output beams are produced from the second input beam component.

6. The optical device according to claim 5, wherein the first group of adjacent LC cells comprise the first, second, and third LC cells and the second group of adjacent LC cells comprise the fourth, fifth, and sixth LC cells.

7. The optical device according to claim 1, wherein the LC structure further includes a plurality of control electrodes that are arranged on a first side of the LC cells and the electrode for applying the common electrical bias to the LC cells is arranged on a second side of the LC cells that is opposite to the first side.

8. An optical device configured to switch and attenuate an input beam in response to a single control signal, comprising:
a birefringent displacer disposed in an optical path of an input beam and optical paths of multiple output beams that are produced from components of the input beam;
a liquid crystal (LC) structure for conditioning the polarization state of incident light and disposed in optical paths of the components of the input beam and the optical paths of the multiple output beams, the LC structure having a plurality of LC cells and a control electrode that applies the single control signal; and
a half-wave plate disposed between the birefringent displacer and the LC structure and configured to rotate the polarization of an input beam component and the output beams that pass therethrough.

9. The optical device according to claim 8, wherein the LC cells include a first group of adjacent LC cells and a second group of adjacent LC cells, and the first input beam component and the output beams produced from the first input beam component pass through the first group of adjacent LC cells and the second input beam component and the output beams produced from the second input beam component pass through the second group of adjacent LC cells.

10. The optical device according to claim 9, wherein the half-wave plate is disposed in optical paths of beams passing through the second group of adjacent LC cells and not in optical paths of beams passing through the first group of adjacent LC cells.

11. The optical device according to claim 8, further comprising a second birefringent displacer disposed in the optical paths of the components of the input beam after the components of the input beam have passed through the LC structure, wherein the second birefringent displacer produces the multiple output beams from the components of the input beam.

12. The optical device according to claim 11, further comprising a reflective element disposed in the optical paths of the multiple output beams to redirect the multiple output beams back through the second birefringent displacer, the LC structure, and the first birefringent displacer.

13. The optical device according to claim 12, further comprising a quarter-wave plate disposed between the second birefringent displacer and the reflective element.

14. A wavelength selective switch comprising:
a wavelength dispersive element for separating an input beam into its wavelength components;
a birefringent displacer disposed in optical paths of the wavelength components and optical paths of multiple output beams that are produced from the wavelength components;
a liquid crystal (LC) structure for conditioning the polarization state of incident light and disposed in the optical paths of the wavelength components and the optical paths of the multiple output beams, the LC structure having a plurality of LC cells arranged in rows and columns; and
a half-wave plate disposed between the birefringent displacer and the LC structure and configured to rotate the polarization of an input beam component and the output beams that pass therethrough.

15. The wavelength selective switch according to claim 14, wherein the LC structure includes a control electrode that applies the same control signal to all of the LC cells.

16. The wavelength selective switch according to claim 15, wherein the LC cells include a first group of adjacent LC cell rows and a second group of adjacent LC cell rows, and all p-components of the wavelength components pass through the LC cells of the first group and all s-components of the wavelength components pass through the LC cells of the second group.

17. The wavelength selective switch according to claim 16, wherein the half-wave plate is disposed in optical paths of beams passing through the second group of adjacent LC cells and not in optical paths of beams passing through the first group of adjacent LC cells.

18. The wavelength selective switch according to claim 15, further comprising a second birefringent displacer for producing the multiple output beams from the wavelength components of the input beam.

19. The wavelength selective switch according to claim 18, further comprising a reflective element disposed in the optical paths of the multiple output beams to redirect the multiple output beams back through the second birefringent displacer, the LC structure, and the first birefringent displacer.

20. The wavelength selective switch according to claim 19, further comprising a quarter-wave plate disposed between the second birefringent displacer and the reflective element.
